(19) United States
(12) Patent Application Publication
(10) Pub. No.: US 2025/0174793 A1
(43) Pub. Date: May 29, 2025

(54) POWER STORAGE DEVICE

(71) Applicant: TOYOTA JIDOSHA KABUSHIKI KAISHA, Toyota-shi (JP)

(72) Inventors: Ryuma OSAKA, Toyota-shi (JP); Shungo IIZUKA, Toyota-shi (JP); Yusuke SUZUKI, Toyota-shi (JP); Masanori KODERA, Toyota-shi (JP)

(73) Assignee: TOYOTA JIDOSHA KABUSHIKI KAISHA, Toyota-shi (JP)

(21) Appl. No.: 18/944,839

(22) Filed: Nov. 12, 2024

(30) Foreign Application Priority Data
Nov. 29, 2023 (JP) 2023-201335

(51) Int. Cl. H01M 50/242; H01M 10/04; H01M 10/613; H01M 10/625; H01M 10/6556; H01M 10/6567; H01M 50/249

(52) U.S. Cl. CPC H01M 50/242; H01M 10/0481; H01M 10/613; H01M 10/625; H01M 10/6556; H01M 10/6567; H01M 50/249

(57) ABSTRACT

A power storage device includes: at least one power storage module; and a contour body that accommodates the power storage module, wherein the contour body includes a first plate-shaped member and a second plate-shaped member, the first plate-shaped member is located below the power storage module, the second plate-shaped member is located below the first plate-shaped member, a liquid path is formed by the first plate-shaped member and the second plate-shaped member, and a strength of the second plate-shaped member is lower than a strength of the first plate-shaped member.

### CROSS REFERENCE TO RELATED APPLICATIONS

This nonprovisional application is based on Japanese Patent Application No. 2023-201335 filed on Nov. 29, 2023 with the Japan Patent Office, the entire contents of which are hereby incorporated by reference.

### BACKGROUND

### Field

The present disclosure relates to a power storage device.

### Description of the Background Art

For example, Japanese Patent Laying-Open No. 2019-197648 discloses a power storage device in which a power storage module is disposed on a cooling device for cooling the power storage module.

### SUMMARY

In the structure of the power storage device disclosed in Japanese Patent Laying-Open No. 2019-197648, it is concerned that when an impact is applied to the cooling device to break the cooling device, coolant in the cooling device may be splashed onto the power storage module.

The present disclosure has been made in view of the above-described problem, and has an object to provide a power storage device including a cooling device, wherein when an impact force is applied to the cooling device, coolant flowing in the cooling device is suppressed from being splashed onto a power storage module in response to breakage of the cooling device.

A power storage device according to the present disclosure is disposed at a lower portion of a vehicle, the power storage device including at least one power storage module; a contour body that accommodates the power storage module; and an upper cover that covers the power storage module, wherein the contour body includes a first plate-shaped member and a second plate-shaped member, the first plate-shaped member is located below the power storage module, the second plate-shaped member is located below the first plate-shaped member, a liquid path is formed by the first plate-shaped member and the second plate-shaped member, a strength of the second plate-shaped member is lower than a strength of the first plate-shaped member.

A plate thickness of the second plate-shaped member is thinner than a plate thickness of the first plate-shaped member.

The second plate-shaped member is composed of a material having a strength different from the strength of the first plate-shaped member.

The second plate-shaped member is composed of a resin material, and the first plate-shaped member is composed of a metal.

The power storage device further includes a third plate-shaped member, wherein the third plate-shaped member is disposed to face a lower surface of the second plate-shaped member, and a clearance is formed between the third plate-shaped member and the second plate-shaped member.

The power storage device further includes a strength member and a block, wherein the strength member is provided in the contour body, and the block is disposed below the strength member and in abutment with the second plate-shaped member and the third plate-shaped member.

The third plate-shaped member constitutes a lower surface of a vehicle.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically showing a vehicle 1 including a power storage device 10 according to the present embodiment.

FIG. 2 is a perspective view schematically showing the power storage device according to one embodiment of the present disclosure.

FIG. 3 is an exploded perspective view of power storage device 10 shown in FIG. 2.

FIG. 4 is a cross sectional view along a line IV-IV in FIG. 2.

### DESCRIPTION OF THE PREFERRED EMBODIMENTS

Embodiments of the present disclosure will be described with reference to figures. It should be noted that in the figures described below, the same or corresponding members are denoted by the same reference characters.

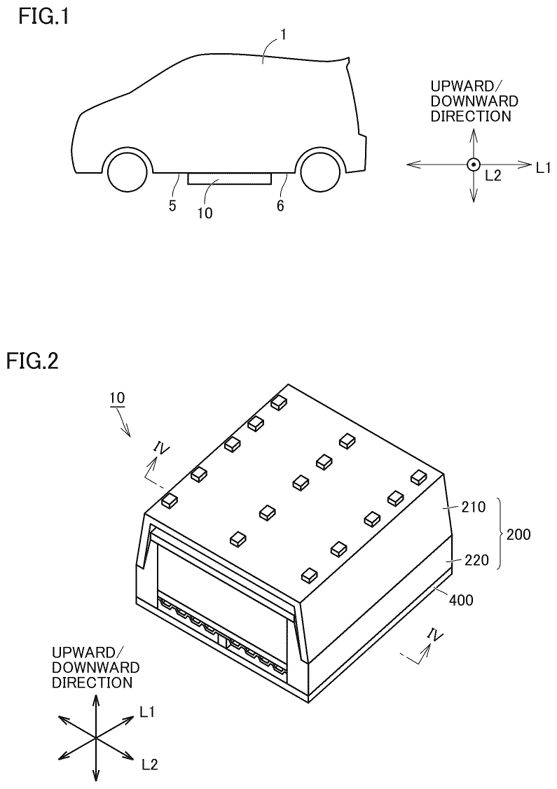

FIG. 1 is a diagram schematically showing a vehicle 1 including a power storage device 10 according to the present embodiment. Power storage device 10 is mounted, for example, at a lower portion 5 of vehicle 1. It should be noted that lower portion 5 of vehicle 1 means a portion below a floor panel 6 when vehicle 2 includes floor panel 6.

It should be noted that in FIG. 1 and the like, a first direction L1 indicates a frontward/rearward direction of vehicle 1, and a second direction L2 indicates a vehicle width direction of vehicle 2.

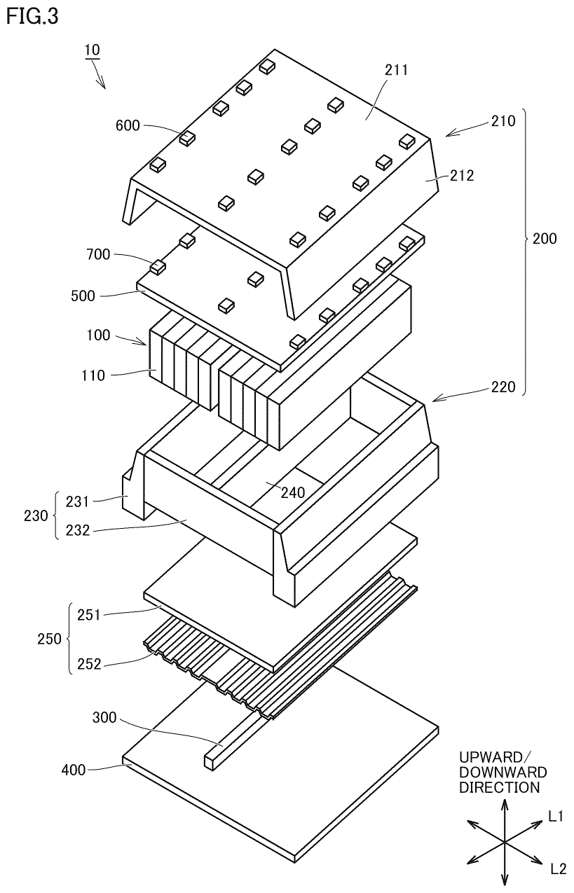

FIG. 2 is a perspective view schematically showing the power storage device according to one embodiment of the present disclosure. FIG. 3 is an exploded perspective view of power storage device 10 shown in FIG. 2.

As shown in FIG. 3, power storage device 10 includes a power storage module 100, an accommodation case 200, a block 300, a protection plate 400, a pressing plate 500, outer elastic bodies 600, and inner elastic bodies 700. Power storage module 100 is accommodated in accommodation case 200. It should be noted that protection plate 400 is an example of the “third plate-shaped member” in the present disclosure.

Power storage module 100 includes a plurality of power storage cells 110 arranged side by side in second direction L2. Each of the power storage cells is formed to be elongated in first direction L1. Power storage cell 110 is, for example, a lithium ion battery.

Accommodation case 200 includes an upper cover 210 and a contour body 220. Upper cover 210 includes a top plate 211 and side walls 212. Upper cover 210 is formed to be opened downward. Side walls 212 are each formed to extend in first direction L1. Side walls 212 are a pair of members formed to extend downward from side surfaces of top plate 211 arranged in second direction L2.

Contour body 220 has an outer peripheral wall 230, a strength member 240, and a cooling plate 250. Outer peripheral wall 230 and strength member 240 are formed to surround power storage module 100 on four sides.

Outer peripheral wall 230 has side frames 231 and cross members 232. Side frames 231 are each formed to extend in first direction L1. Side frames 231 are a pair of structural members arranged in second direction L2. An upper surface of each of side frames 231 is located on the same plane as an upper surface of each of cross members 232. Side frame 231 is formed to have a height equal to a sum of the heights of power storage module 100, cooling plate 250 described later, and block 300. End sides of the pair of side frames 231 in second direction L2 are aligned with edge portions, in second direction L2, of the outer peripheral edge portions of side walls 212.

Cross members 232 are each formed to extend in second direction L2. Cross members 232 are a pair of structural members arranged in first direction L1. The upper surface of each of cross members 232 is located on the same plane as the upper surface of each of side frames 231. Cross member 232 is formed to have a height equal to the height of power storage module 100. Cross member 232 is disposed orthogonal to side frames 231. One of the pair of cross members 232 is disposed to be aligned with end portions of side frames 231 in first direction L1, and the other of cross members 232 is disposed to be aligned with the other end portions of side frames 231 in first direction L1. It should be noted that a pair of EA members (not shown) may be formed on both end surfaces of the pair of side frames 231 in second direction L2.

Strength member 240 is formed to extend in first direction L1. One end surface of strength member 240 in first direction L1 is in contact with a side surface of cross member 232, and the other end surface of strength member 240 in first direction L1 is in contact with a side surface of the other cross member 232. Further, strength member 240 is disposed to extend through the center of each cross member 232 in second direction L2. Strength member 240 is formed to have a height equal to the height of cross member 232.

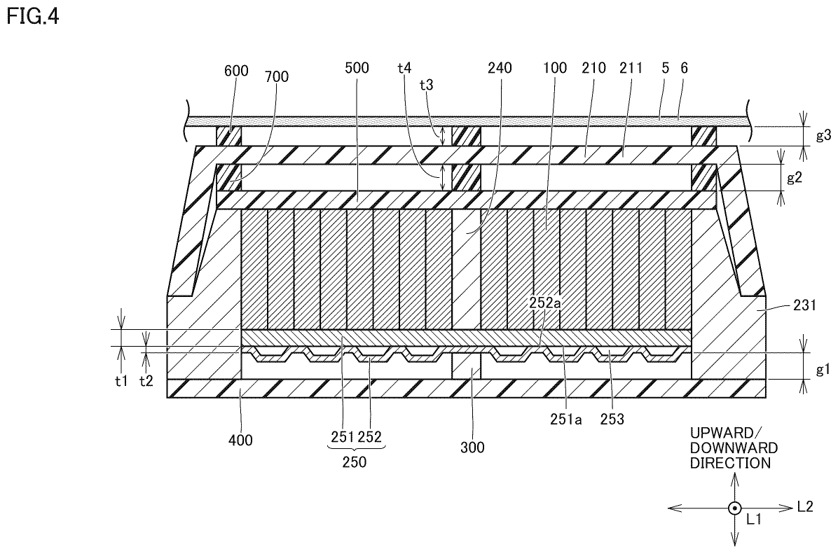

FIG. 4 is a cross sectional view along a line IV-IV in FIG. 2. Cooling plate 250 has a first plate-shaped member 251 and a second plate-shaped member 252. Cooling plate 250 is located directly below strength member 240. Cooling plate 250 supports power storage module 100 in the upward/downward direction.

First plate-shaped member 251 is a plate formed to have a length coinciding with the length of side frame 231 in first direction L1 and have a length coinciding with the length of cross member 232 in second direction L2. First plate-shaped member 251 is located directly below cross member 232 and strength member 240. Cooling plate 250 supports power storage module 100 in the upward/downward direction.

Second plate-shaped member 252 is a plate formed to have the same outer shape as that of first plate-shaped member 251. Second plate-shaped member 252 is provided with a plurality of groove portions each extending in first direction L1. Further, second plate-shaped member 252 is, for example, welded to lower surface 251a of first plate-shaped member 251 at welding portions 252a, thereby forming a plurality of liquid paths 253 between first plate-shaped member 251 and second plate-shaped member 252.

Here, an impact strength [kJ/m] of second plate-shaped member 252 is lower than an impact strength [kJ/m] of first plate-shaped member 251. It should be noted that the impact strength [kJ/m] includes Izod impact strength, Charpy impact strength, and tensile impact strength. Here, the Izod impact strength is measured based on the test method of JIS K 7110. The Charpy impact strength is measured based on the test method of JIS K 7111-1. The tensile impact strength is measured based on the test method of JIS K 7160. That is, the impact strength [kJ/m] is calculated based on impact energy, at the time of breakage, absorbed by a member per unit width when the member is broken by applying an impact to the member. It should be noted that the impact strength is an example of the “strength” in the present disclosure.

For example, cooling plate 250 may be composed of aluminum. Specifically, A3003-0 having a thickness of 2.5 mm or 1.2 mm may be used. Alternatively, cooling plate 250 may be composed of a resin material such as polyvinyl chloride. Further, second plate-shaped member 252 may be composed of a plate material thinner than first plate-shaped member 251. For example, second plate-shaped member 252 may be formed to have a thickness t2 that is ⅓ times or more and ½ times or less as large as a thickness t1 of first plate-shaped member 251.

Referring again to FIG. 3, block 300 is formed to extend in first direction L1. Block 300 is formed such that the size thereof in first direction L1 coincides with the size of outer peripheral wall 230 in first direction L1. Further, block 300 is formed such that the size thereof in second direction L2 coincides with the size of strength member 240 in second direction L2. It should be noted that block 300 is located below cooling plate 250 at a position overlapping with strength member 240 in the upward/downward direction. The upper surface of block 300 is in contact with the lower surface of second plate-shaped member 252. The lower surface of block 300 is located on the same plane as the lower surface of side frame 231.

Protection plate 400 is disposed to face the lower surface of second plate-shaped member 252. Protection plate 400 is formed such that the outer peripheral edge portion of protection plate 400 is aligned with the outer peripheral edge portion of outer peripheral wall 230. Protection plate 400 is a flat plate formed on the same plane as the lower surface of side frame 231 and the lower surface of block 300. That is, a clearance g1 corresponding to the height of each of side frame 231 and block 300 is formed between protection plate 400 and second plate-shaped member 252. Further, protection plate 400 constitutes a lower surface of vehicle 1.

Clearance g1 is narrower than a clearance g2 formed by top plate 211 and pressing plate 500. Inner elastic bodies 700 described later are disposed in clearance g2. Clearance g1 is narrower than a clearance g3 formed by lower portion 5 of vehicle 1 and top plate 211. Outer elastic bodies 600 described later are disposed in clearance g3. Block 300 disposed in clearance g1 has a function of suppressing deflection of the protection plate. Each of elastic bodies 600, 700 disposed in clearances g2, g3 has a function of suppressing deflection of top plate 211. It should be noted that block 300 disposed in clearance g1 is less likely to be deformed as compared with elastic bodies 600, 700. Therefore, since block 300 can suppress the deflection as compared with elastic bodies 600, 700, clearance g1 can be configured to be narrower than each of clearance g2 and clearance g3.

Pressing plate 500 is located on the upper surface of contour body 220. Pressing plate 500 is disposed over power storage module 100 and strength member 240. Pressing plate 500 presses power storage module 100 toward cooling plate 250. Pressing plate 500 is formed to have such a size that the outer peripheral edge portion of pressing plate 500 is in contact with the upper surface of outer peripheral wall 230. Pressing plate 500 is formed to have a flat plate shape. Pressing plate 500 is composed of a synthetic resin or the like.

Referring again to FIG. 4, each of outer elastic bodies 600 is provided on the upper surface of top plate 211. Outer elastic body 600 is formed to have a flat rectangular parallelepiped shape. Outer elastic body 600 is formed to have a thickness t3 corresponding to the size of clearance g3. Outer elastic body 600 is composed of an elastic material such as urethane. The plurality of outer elastic bodies 600 are arranged at intervals in each of first direction L1 and second direction L2. Each of outer elastic bodies 600 is located above side frame 231 and strength member 240. Outer elastic body 600 is sandwiched between lower portion 5 of vehicle 1 and top plate 211.

Each of inner elastic bodies 700 is provided on the lower surface of upper cover 210. Inner elastic body 700 is composed of an elastic material such as urethane. Inner elastic body 700 is formed to have a flat rectangular parallelepiped shape. Inner elastic body 700 is formed to have a thickness t4 corresponding to the size of clearance g2. Inner elastic body 700 may be formed to have the same shape as that of outer elastic body 600. The plurality of inner elastic bodies 700 are arranged at intervals in each of first direction L1 and second direction L2. Each of inner elastic bodies 700 is located below outer elastic body 600 so as to overlap with outer elastic body 600. Inner elastic body 700 is located above side frame 231 and strength member 240. Inner elastic body 700 is sandwiched between top plate 211 and pressing plate 500. It should be noted that thickness t4 of inner elastic body 700 is thicker than thickness t3 of outer elastic body 600.

With outer elastic bodies 600 and inner elastic bodies 700, power storage device 10 mounted on bottom portion 5 can have a function of suppressing vibration propagated from vehicle 1.

A spring constant [N/mm] of each of inner elastic bodies 700 is larger than a spring constant [N/mm] of each of outer elastic bodies 600. It should be noted that the “spring constant” includes a static spring constant and a dynamic spring constant. A method of measuring each of the static spring constant and the dynamic spring constant is based on JIS K 6385. That is, the spring constant is calculated based on a relation between a load applied to each of elastic bodies 600, 700 and deflection of each of elastic bodies 600, 700 on that occasion.

A hardness (type C) of each of inner elastic bodies 700 is larger than a hardness (type C) of each of outer elastic bodies 600. A method of measuring the hardness (type C) is based on JIS K 7312. That is, the hardness is calculated based on reaction force applied to a needle from a test piece of each of elastic bodies 600, 700 when the test piece is pressed by the needle.

According to the embodiment of the present disclosure, the impact strength [kJ/m] of second plate-shaped member 252 included in cooling plate 250 is lower than that of first plate-shaped member 251. Therefore, when an upward impact is applied to cooling plate 250 from below the vehicle, second plate-shaped member 252 having a lower impact strength than that of first plate-shaped member 251 is broken simultaneously with or prior to first plate-shaped member 251. Thus, coolant flowing in liquid path 253 of cooling plate 250 thus broken flows downward with respect to the vehicle by gravity along the damaged portion of second plate-shaped member 252, thereby suppressing the coolant from being splashed onto power storage module 100.

It has been illustratively described that first plate-shaped member 251 (cooling plate 250) is composed of a resin material in the above-described example, but the present disclosure is not limited thereto. For example, first plate-shaped member 251 may be composed of a metal material.

It has been illustratively described that each of first plate-shaped member 251 and second plate-shaped member 252 is composed of polyvinyl chloride in the above-described example, but the present disclosure is not limited thereto. First plate-shaped member 251 and second plate-shaped member 252 may be composed of materials having different impact strengths [kJ/m2] per unit area. For example, first plate-shaped member 251 may be composed of glass fiber reinforced plastic, and second plate-shaped member 252 may be composed of polyvinyl chloride.

It has been illustratively described that the impact strength [kJ/m] of second plate-shaped member 252 is lower than the impact strength of first plate-shaped member 251 in the above-described example, but the present disclosure is not limited thereto. For example, a breaking load [N] of second plate-shaped member 252 may be smaller than a breaking load [N] of first plate-shaped member 251. It should be noted that the breaking load [N] includes at least one of a bending breaking load [N] and a compression breaking load [N]. Here, the bending breaking load [N] is measured based on the test method of JIS K 7171. That is, the bending breaking load [N] is found by pressing an indenter against a member placed on a support table so as to deflect the member and measuring a load at the time of breakage of the member. Further, the compression breaking load [N] is measured based on the test method of JIS K 7181. That is, the compression breaking load [N] is found by compressing a member using a pressure-applying plate and measuring a load at the time of breakage of the member. It should be noted that the breaking load is an example of the “strength” in the present disclosure.

According to another disclosed embodiment, second plate-shaped member 252 included in cooling plate 250 has a smaller breaking load [N] than that of first plate-shaped member 251. Therefore, when an impact from a lateral side of the vehicle is applied to cooling plate 250 through side frame 231, second plate-shaped member 252 having a smaller breaking load than that of first plate-shaped member 251 is broken prior to or simultaneously with first plate-shaped member 251. Thus, coolant flowing in liquid path 253 of cooling plate 250 thus broken flows downward with respect to the vehicle by gravity along the damaged portion of second plate-shaped member 252, thereby suppressing the coolant from being splashed onto power storage module 100.

It has been illustratively described that clearance g1 is narrower than each of clearances g2 and g3 in the above-described example, but the present disclosure is not limited thereto. For example, clearance g1 may be wider than one of clearance g2 and clearance g3, or clearance g1 may be formed as wide as one of clearance g2 and clearance g3.

Although the embodiments of the present disclosure have been described and shown in detail, it is clearly understood that the same is by way of illustration and example only and is not to be taken by way of limitation. The scope of the present disclosure is defined by the terms of the claims, and is intended to include any modifications within the scope and meaning equivalent to the terms of the claims.

What is claimed is:

1. A power storage device comprising:
at least one power storage module; and
a contour body that accommodates the power storage module, wherein
the contour body includes a first plate-shaped member and a second plate-shaped member,
the first plate-shaped member is located below the power storage module,
the second plate-shaped member is located below the first plate-shaped member,
a liquid path is formed by the first plate-shaped member and the second plate-shaped member, and
a strength of the second plate-shaped member is lower than a strength of the first plate-shaped member.

2. The power storage device according to claim 1, wherein a plate thickness of the second plate-shaped member is thinner than a plate thickness of the first plate-shaped member.

3. The power storage device according to claim 1, wherein the second plate-shaped member is composed of a material having a strength different from the strength of the first plate-shaped member.

4. The power storage device according to claim 1, wherein the second plate-shaped member is composed of a resin material, and the first plate-shaped member is composed of a metal.

5. The power storage device according to claim 1, further comprising a third plate-shaped member, wherein
the third plate-shaped member is disposed to face a lower surface of the second plate-shaped member, and
a clearance is formed between the third plate-shaped member and the second plate-shaped member.

6. The power storage device according to claim 5, further comprising a strength member and a block, wherein
the strength member is provided in the contour body, and
the block is disposed below the strength member and in abutment with the second plate-shaped member and the third plate-shaped member.

7. The power storage device according to claim 5, wherein the third plate-shaped member constitutes a lower surface of a vehicle.
